(19) United States
(12) Patent Application Publication
(10) Pub. No.: US 2023/0012341 A1
(43) Pub. Date: Jan. 12, 2023

(54) POLYCRYSTALLINE DIAMOND CONSTRUCTIONS & METHODS OF MAKING SAME

(71) Applicants: Element Six (UK) Limited, Didcot, Oxfordshire (GB); Element Six GmbH, Burghaun (DE)

(72) Inventors: Igor Yurievich Konyashin, Burghaun (DE); Rachael Fiona Ambury, Didcot (GB); Sebastian Farag, Burghaun (DE); Roger William Nigel Nilen, Didcot (GB); Raymond Anthony Spits, Didcot (GB)

(73) Assignees: Element Six (UK) Limited, Didcot, Oxfordshire (GB); Element Six GmbH, Burghaun (DE)

(21) Appl. No.: 17/784,892

(22) PCT Filed: Dec. 31, 2020
(86) PCT No.: PCT/EP2020/088076

§ 371 Date: Jun. 13, 2022

(30) Foreign Application Priority Data
Dec. 31, 2019 (GB) 1919480.2

(51) Int. Cl. B22F 7/06; B22F 1/00; C22C 29/08; B01J 3/06

(52) U.S. Cl. CPC B22F 7/064; B22F 1/09; C22C 29/08; B01J 3/06; C22C 2026/006

(57) ABSTRACT

A polycrystalline diamond construction has a body of polycrystalline diamond (PCD) material; and a cemented carbide substrate bonded to the body of polycrystalline material along an interface. The cemented carbide substrate has tungsten carbide particles bonded together by a binder material, the binder material comprising Co; and the tungsten carbide particles form at least around 70 weight percent and at most around 95 weight percent of the substrate. The cemented carbide substrate has a bulk volume, the bulk volume of the cemented carbide substrate having at least around 0.1 vol. % of inclusions of free carbon having a largest average size in any one or more dimensions of less than around 40 microns.

### FIELD

This disclosure relates to polycrystalline diamond (PCD) constructions and methods of making such constructions, and tools comprising the same, particularly but not exclusively for use in rock degradation or drilling, or for boring into the earth.

### BACKGROUND

Polycrystalline superhard materials, such as polycrystalline diamond (PCD) and polycrystalline cubic boron nitride (PCBN) may be used in a wide variety of tools for cutting, machining, drilling or degrading hard or abrasive materials such as rock, metal, ceramics, composites and wood-containing materials. In particular, tool inserts in the form of cutting elements comprising PCD material are widely used in drill bits for boring into the earth to extract oil or gas. The working life of superhard tool inserts may be limited by fracture of the superhard material, including by spalling and chipping, or by wear of the tool insert.

Cutting elements such as those for use in rock drill bits or other cutting tools typically have a body in the form of a substrate which has an interface end/surface and a superhard material which forms a cutting layer bonded to the interface surface of the substrate by, for example, a sintering process. The substrate is generally formed of a tungsten carbide-cobalt alloy, sometimes referred to as cemented tungsten carbide and the superhard material layer is typically polycrystalline diamond (PCD), polycrystalline cubic boron nitride (PCBN) or a thermally stable product TSP material such as thermally stable polycrystalline diamond.

Polycrystalline diamond (PCD) is an example of a superhard material (also called a superabrasive or ultra hard material) comprising a mass of substantially inter-grown diamond grains, forming a skeletal mass defining interstices between the diamond grains. PCD material typically comprises at least about 80 volume % of diamond and is conventionally made by subjecting an aggregated mass of diamond grains to an ultra-high pressure of greater than about 5 GPa, and temperature of at least about 1,200° C., for example. A material wholly or partly filling the interstices may be referred to as filler or binder material.

PCD is typically formed in the presence of a sintering aid such as cobalt, which promotes the inter-growth of diamond grains. Suitable sintering aids for PCD are also commonly referred to as a solvent-catalyst material for diamond, owing to their function of dissolving, to some extent, the diamond and catalysing its re-precipitation. A solvent-catalyst for diamond is understood be a material that is capable of promoting the growth of diamond or the direct diamond-to-diamond inter-growth between diamond grains at a pressure and temperature condition at which diamond is thermodynamically stable. Consequently the interstices within the sintered PCD product may be wholly or partially filled with residual solvent-catalyst material. Most typically, PCD is often formed on a cobalt-cemented tungsten carbide substrate, which provides a source of cobalt solvent-catalyst for the PCD. Materials that do not promote substantial coherent intergrowth between the diamond grains may themselves form strong bonds with diamond grains, but are not suitable solvent-catalysts for PCD sintering.

Cemented tungsten carbide which may be used to form a suitable substrate is formed from carbide particles being dispersed in a cobalt matrix by mixing tungsten carbide particles/grains and cobalt together then heating to solidify. To form the cutting element with a superhard material layer such as PCD or PCBN, diamond particles or grains or CBN grains are placed adjacent the cemented tungsten carbide body in a refractory metal enclosure such as a niobium enclosure and are subjected to high pressure and high temperature so that inter-grain bonding between the diamond grains or CBN grains occurs, forming a polycrystalline superhard diamond or polycrystalline CBN layer.

In some instances, the substrate may be fully cured prior to attachment to the superhard material layer whereas in other cases, the substrate may be green, that is, not fully cured. In the latter case, the substrate may fully cure during the HTHP sintering process. The substrate may be in powder form and may solidify during the sintering process used to sinter the superhard material layer.

Ever increasing drives for improved productivity in the earth boring field place ever increasing demands on the materials used for cutting rock. Specifically, cutting tools with improved resistance to various failure mechanisms such are required to achieve faster cut rates and longer tool life.

Cutting elements or tool inserts comprising PCD material are widely used in drill bits for boring into the earth in the oil and gas drilling industry. Rock drilling and other operations require certain mechanical properties such as high abrasion resistance, impact resistance, erosion and corrosion resistance and high fracture toughness.

Cutters formed of the most wear resistant grades of PCD material bonded to cemented carbide substrates usually suffer from a catastrophic fracture before the cutter has worn out as, during the use of these cutters, cracks grow until they reach a critical length at which catastrophic failure can occur, namely when a large portion of the PCD and/or cemented carbide substrate breaks away. These long, fast growing cracks encountered during use of conventionally sintered PCD cutters may result in short tool life.

Furthermore, despite their high strength, polycrystalline diamond (PCD) materials are usually susceptible to impact fracture due to their low fracture toughness. Improving fracture toughness without adversely affecting the material's high strength and abrasion resistance which are critical for the material's ability to cut through rock, for example, is a challenging task.

Polycrystalline diamond (PCD) is a super-hard, also known as superabrasive, material comprising a mass of inter-grown diamond grains and interstices between the diamond grains. PCD may be made by subjecting an aggregated mass of diamond grains to an ultra-high pressure and temperature. A material wholly or partly filling the interstices may be referred to as filler material. PCD may be formed in the presence of a sintering aid such as cobalt, which is capable of promoting the inter-growth of diamond grains and can also act as a tough, ductile and impact-resistance binder ensuring a certain level of PCD fracture toughness. The sintering aid may be referred to as a catalyst/binder material for diamond, owing to its function of dissolving diamond to some extent and catalysing its re-precipitation. A catalyst/binder for diamond is understood to be a material that is capable of promoting the growth of diamond or the direct diamond-to-diamond inter-growth between diamond grains at a pressure and temperature condition at which diamond is thermodynamically stable as well as to bound diamond grains together forming a superhard and tough material. Consequently, the interstices within the sintered PCD product may be wholly or partially filled with residual catalyst/binder material. PCD may be formed on a WC-Co cemented carbide substrate, which may provide a source of cobalt catalyst/binder for the PCD.

PCD may be used in a wide variety of tools for cutting, machining, drilling or degrading hard or abrasive materials such as rock, metal, ceramics, composites and wood-containing materials. For example, PCD elements may be used as cutting elements on drill bits used for boring into the earth in the oil and gas drilling industry. Such cutting elements for use in oil and gas drilling applications are typically formed of a layer of PCD bonded to a cemented carbide substrate.

A known problem with respect to the fabrication of conventional PCD cutting elements is related to the formation of numerous precipitates of WC, in the form of platelets, at the interface of the body of PCD material with the cemented carbide substrate, which are typically referred to in literature as “WC plumes”. The presence of such plumes at the interface leads to reduced performance of the PCD cutting elements in different applications. A common viewpoint on a reason for the formation of WC plumes is the presence of high amounts of tungsten dissolved in the binder of conventional cemented carbide substrates. It is well known that the solubility of tungsten in the liquid Co-based binder of cemented carbides is indirectly proportional to the total carbon content (I. Konyashin. Cemented Carbides for Mining, Construction and Wear Parts, Comprehensive Hard Materials, Elsevier Science and Technology, Editor-in-Chief V. Sarin, 2014, 425-251), so that a lower carbon content in cemented carbides corresponds to a higher amount of tungsten dissolved in the carbide binder. When liquid Co-based binders start infiltrating the PCD layer during sintering they become saturated with carbon, due to its diffusion from the PCD layer, and an excessive amount of tungsten dissolved in the binder precipitates as platelet-like WC plumes at the PCD/carbide interface.

There is therefore a need for a PCD composite construction comprising a body of PCD material bonded to a substrate that has good or improved mechanical properties such as fracture toughness and impact resistance and a method of forming such composites.

### SUMMARY

Viewed from a first aspect there is provided a polycrystalline diamond construction comprising:
a body of polycrystalline diamond (PCD) material; and
a cemented carbide substrate bonded to the body of polycrystalline material along an interface; wherein
the cemented carbide substrate comprises tungsten carbide particles bonded together by a binder material, the binder material comprising Co; and
the tungsten carbide particles form at least around 70 weight percent and at most around 95 weight percent of the substrate;
wherein the cemented carbide substrate has a bulk volume, the bulk volume of the cemented carbide substrate comprising at least around 0.1 vol. % to around 3 vol % of inclusions of any one or more of free carbon, SP²-hybridised carbon, or SP³-hybridised carbon, the inclusions having a largest average size in any one or more dimensions of less than around 40 microns.

Viewed from a second aspect there is provided a method of making the polycrystalline diamond construction of any one of the preceding claims, the method comprising:
milling a tungsten carbide powder with a binder material and a mass of carbon to form a milled powder, the binder material comprising Co; and the mass of carbon comprising any one or more of graphite or amorphous carbon in an amount corresponding to the equivalent carbon content (ETC) with respect to the milled WC powder of equal to or more than around 6.2 wt. %;
compacting the milled powder to form a green body;
sintering the green body in a vacuum or inert gas atmosphere to form a first pre-composite body;
sintering the first pre-composite body to form a cemented carbide substrate;
placing the cemented carbide substrate into a cannister and adding a mass of diamond grains or particles to form a second pre-sinter assembly; and

treating the second pre-sinter assembly in the presence of a catalyst/solvent material for diamond at an ultra-high pressure of around 6 GPa or greater and a temperature at which the diamond material is more thermodynamically stable than graphite to sinter together the diamond grains to form the polycrystalline diamond compact element.

Viewed from a further aspect there is provided a tool comprising the polycrystalline diamond construction defined above, the tool being for cutting, milling, grinding, drilling, earth boring, rock drilling or other abrasive applications.

The tool may comprise, for example, a drill bit for earth boring or rock drilling, a rotary fixed-cutter bit for use in the oil and gas drilling industry, or a rolling cone drill bit, a hole opening tool, an expandable tool, a reamer or other earth boring tools.

Viewed from another aspect there is provided a drill bit or a cutter or a component therefor comprising the polycrystalline diamond construction defined above.

### BRIEF DESCRIPTION OF THE DRAWINGS

Various versions will now be described by way of example and with reference to the accompanying drawings in which:

FIG. 1 is a schematic perspective view of an example PCD cutter element for a drill bit for boring into the earth;

FIG. 2 is a is a schematic partial cross-section through an example of a PCD cutter element;

FIG. 3a is an image of the microstructure of a substrate for an example PCD construction before sintering with diamond grains to form the example PCD construction;

FIG. 3b is an image of the microstructure of the substrate of FIG. 3a after sintering with diamond grains to form the example PCD construction;

FIG. 4a is an image of the microstructure of a substrate for a further example PCD construction before sintering with diamond grains to form the example PCD construction;

FIG. 4b is an image of the microstructure of the substrate of FIG. 4a after sintering with diamond grains to form the example PCD construction; and

FIG. 5 is a vertical section of the W-C-Co phase diagram through the carbon angle with a cobalt content of 20 mass %.

### DESCRIPTION

As used herein, a “superhard material” is a material having a Vickers hardness of at least about 28 GPa. Diamond and cubic boron nitride (cBN) material are examples of superhard materials.

As used herein, a “superhard construction” means a construction comprising a body of polycrystalline superhard material. In such a construction, a substrate may be attached thereto.

As used herein, polycrystalline diamond (PCD) is a type of polycrystalline superhard (PCS) material comprising a mass of diamond grains, a substantial portion of which are directly inter-bonded with each other and in which the content of diamond is at least about 80 volume percent of the material. In one exemplary PCD material, interstices between the diamond grains may be at least partly filled with a binder material comprising a catalyst for diamond. As used herein, “interstices” or “interstitial regions” are regions between the diamond grains of PCD material. In exemplary PCD material, interstices or interstitial regions may be substantially or partially filled with a material other than diamond, or they may be substantially empty. PCD material may comprise at least a region from which catalyst material has been removed from the interstices, leaving interstitial voids between the diamond grains.

A “catalyst material” for a superhard material is capable of promoting the growth or sintering of the superhard material.

The term “substrate” as used herein means any substrate over which the superhard material layer is formed. For example, a “substrate” as used herein may be a transition layer formed over another substrate.

As used herein, the term “integrally formed” regions or parts are produced contiguous with each other and are not separated by a different kind of material.

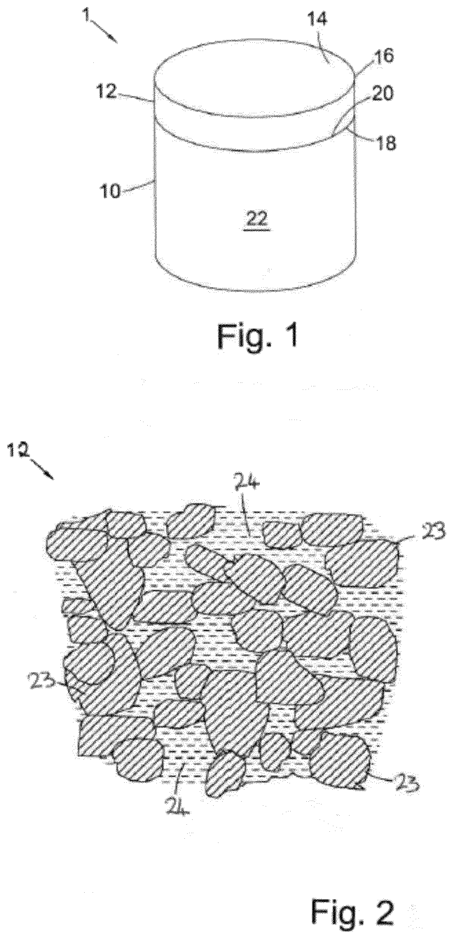

In an example as shown in FIG. 1, a cutting element 1 includes a substrate 10 with a layer of superhard material 12 formed on the substrate 10. The substrate 10 may be formed of a hard material such as cemented tungsten carbide. The superhard material 12 may be, for example, polycrystalline diamond (PCD), or a thermally stable product such as thermally stable PCD (TSP). The cutting element 1 may be mounted into a bit body such as a drag bit body (not shown) and may be suitable, for example, for use as a cutter insert for a drill bit for boring into the earth.

The exposed top surface of the superhard material opposite the substrate forms the cutting face 14, which is the surface which, along with its edge 16, performs the cutting in use.

At one end of the substrate 10 is an interface surface 18 that forms an interface with the superhard material layer 12 which is attached thereto at this interface surface. As shown in the example of FIG. 1, the substrate 10 is generally cylindrical and has a peripheral surface 20 and a peripheral top edge 22.

As used herein, a PCD grade is a PCD material characterised in terms of the volume content and size of diamond grains, the volume content of interstitial regions between the diamond grains and composition of material that may be present within the interstitial regions. A grade of PCD material may be made by a process including providing an aggregate mass of diamond grains having a size distribution suitable for the grade, optionally introducing catalyst material or additive material into the aggregate mass, and subjecting the aggregated mass in the presence of a source of catalyst material for diamond to a pressure and temperature at which diamond is more thermodynamically stable than graphite and at which the catalyst material is molten. Under these conditions, molten catalyst material may infiltrate from the source into the aggregated mass and is likely to promote direct intergrowth between the diamond grains in a process of sintering, to form a PCD structure. The aggregate mass may comprise loose diamond grains or diamond grains held together by a binder material and said diamond grains may be natural or synthesised diamond grains.

Different PCD grades may have different microstructures and different mechanical properties, such as elastic (or Young's) modulus E, modulus of elasticity, transverse rupture strength (TRS), toughness (such as so-called K₁C toughness), hardness, density and coefficient of thermal expansion (CTE). Different PCD grades may also perform differently in use. For example, the wear rate and fracture resistance of different PCD grades may be different.

All of the PCD grades may comprise interstitial regions filled with material comprising cobalt metal, which is an example of catalyst material for diamond.

The PCD structure 12 may comprise one or more PCD grades.

FIG. 2 is a cross-section through a PCD material which may form the super hard layer 2 of FIG. 1 in an example cutter. During formation of a conventional polycrystalline diamond construction, the diamond grains 22 are directly interbonded to adjacent grains and the interstices 24 between the grains 22 of super hard material such as diamond grains in the case of PCD, may be at least partly filled with a non-super hard phase material. This non-super hard phase material, also known as a filler material, may comprise residual catalyst/binder material, for example cobalt, nickel or iron.

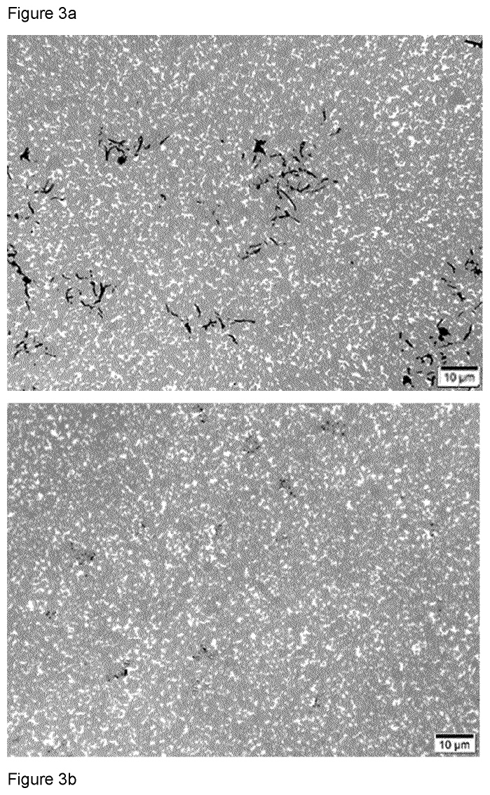

Example PCD constructions are further described with reference to FIGS. 3a to 5. The examples of such PCD constructions include a body of polycrystalline diamond material (PCD), bonded to a cemented carbide substrate along an interface. The cemented carbide substrate includes tungsten carbide particles bonded together by a binder material, the binder material comprising for example Co. The tungsten carbide particles form at least around 70 weight percent and at most around 95 weight percent of the substrate. The bulk volume of the cemented carbide substrate comprises at least around 0.1 vol. % to around 3 vol %, or to around 2.5 vol % or to around 2 vol % of inclusions of any one or more of free carbon, SP²-hybridised carbon, or SP³-hybridised carbon, such as graphite and/or diamond, the inclusions having a largest average size in any one or more dimensions of less than around 40 microns.

In some examples, the inclusions have an average size of less than around 30 microns, and in other examples the inclusions have an average size of less than around 10 microns.

The bulk volume of the cemented carbide substrate may, in some examples, comprise at least around 0.3 vol. % of inclusions.

In some examples, the binder material of the substrate may comprise up to around 50 wt. % Fe.

In further examples, the binder material of the substrate comprises between about 0.1 to about 4 wt. % tungsten and between about 0.05 to about 5 wt. % carbon in solid solution form, and in other examples, the binder material comprises at least about 0.1 weight percent to at most about 5 weight percent of any one or more of V, Ta, Ti, Mo, Zr, Nb, Hf in the form of a solid solution or a carbide phase.

The binder material may comprise at least about 0.1 weight percent and at most about 2 weight percent of any one or more of Re, Ru, Rh, Pd, Re, Os, Ir and Pt in solid solution.

The cemented carbide substrate may, for example, have a thickness from the interface with the body of PCD material of at least around 0.1 mm, or at least around 0.2 mm, or at least around 0.3 mm.

In additional examples, a second cemented carbide substrate may be bonded to the cemented carbide substrate along a second interface which is opposite the interface with the body of PCD material, the second substrate comprising substantially no inclusions of any one or more of free carbon, SP²-hybridised carbon, or SP³-hybridised carbon.

In some examples, an interfacial region between the cemented carbide substrate and the body of PCD material comprises substantially no platelet-like WC grains.

The example polycrystalline diamond constructions may be made by milling a tungsten carbide powder with a binder material and a mass of carbon to form a milled powder, the binder material comprising Co, and the mass of carbon comprising any one or more of graphite or amorphous carbon in an amount corresponding to the equivalent carbon content (ETC) with respect to the milled WC powder of equal to or more than around 6.2 wt. %. The milled powder is compacted to form a green body which is then sintered in a vacuum or inert gas atmosphere to form a first pre-composite body. The first pre-composite body is then sintered to form a cemented carbide substrate. The cemented carbide substrate is placed into a cannister and a mass of diamond grains or particles is added to form a second pre-sinter assembly. The second pre-sinter assembly is subsequently treated in the presence of a catalyst/solvent material for diamond at an ultra-high pressure of around 6 GPa or greater, such as for example, around 6.8 GPa, or around 7 GPa, or around 7.7 Pa, or 8 GPa or greater and at a temperature at which the diamond material is more thermodynamically stable than graphite, to sinter together the diamond grains to form the polycrystalline diamond compact element. The bulk volume of the substrate of the so formed PCD constructions has at least around 0.1 vol. % of inclusions of free carbon, such as graphite, having a largest average size in any one or more dimensions of less than around 40 microns

The step of sintering the green body to form the pre-composite body may include heating the green body up to a temperature of at least around 300° C. in a vacuum followed by annealing for at least around 5 minutes.

In some examples, prior to the step of placing the cemented carbide substrate into the canister, a cemented carbide disc of at least around 2 mm in thickness may be formed which comprises binder material comprising Co, and at least about 0.1 vol. % carbon inclusions in form of graphite. An additional cemented carbide post having a binder material comprising, for example Co, may also be formed and the disc and the post may then be bonded together by sintering either at ambient conditions or at ultra-high pressure to form an example cemented carbide substrate for placing into the canister with the mass of diamond grains or particles.

In such examples, the milled powder may be pressed onto or around a cemented carbide post having a binder material comprising, for example Co to form the green body; and the step of sintering the green body may, for example, comprise sintering the posts with a layer of the milled powder at a temperature in the range of between about 1350° C. to about 1400° C. for between about 10 to about 60 minutes in a vacuum or protective gas.

In an alternative example, the step of bonding the disc and the post may comprise brazing by, for example, placing a barrier interlayer between the post and the disc, the barrier layer having a thickness of at least around 10 pm and comprising any one or more of a metal, a metal carbide, nitride or carbonitride.

In any one or more of the example methods, after the step of sintering the first pre-composite body to form the cemented carbide substrate the method may further comprise the step of selectively de-carburizing a portion of the cemented carbide substrate in a hydrogen atmosphere or an atmosphere of CO₂ at a temperature of at least around 700° C. for at least around 1 hour, the portion having a thickness of at least around 50% of the total height of the cemented carbide substrate.

In any one or more of the example methods, after the step of sintering the first pre-composite body to form the cemented carbide substrate, the method may further comprise carburizing the cemented carbide substrate in an atmosphere comprising any one or more of a hydrocarbon gas, an inert gas or hydrogen at a temperature of at least around 1350° C. for between around 1 hour to around 10 hours.

The step of carburizing may comprise treating the cemented carbide substrate or green body with a powder mixture comprising any one or more of carbon black, graphite or a carbon-containing precursor in an atmosphere comprising any one or more of an inert gas, hydrogen or a gaseous mixture comprising hydrocarbons at a temperature of above around 1000° C. for at least around 1 hour.

In some examples, the step of treating the second pre-sinter assembly comprises subjecting the assembly to a sufficiently high temperature for the catalyst/solvent to be in a liquid state and to a first pressure at which diamond is thermodynamically stable, reducing the first pressure to a second pressure at which the diamond is thermodynamically stable, the temperature being maintained sufficiently high to maintain the catalyst/binder in the liquid state, reducing the temperature to solidify the catalyst/binder and then reducing the pressure and the temperature to an ambient condition to form the example body of polycrystalline diamond material bonded to the cemented carbide substrate.

The PCD constructions according to any one of the examples may be included in or used as a tool for cutting, milling, grinding, drilling, earth boring, rock drilling or other abrasive applications, such as a drill bit for earth boring or rock drilling. The tool comprising the example PCD construction may comprise a rotary fixed-cutter bit for use in the oil and gas drilling industry, such as a rolling cone drill bit, a hole opening tool, an expandable tool, a reamer or another earth boring tool. A drill bit or a cutter or a component therefor may comprise any one or more of the example PCD constructions.

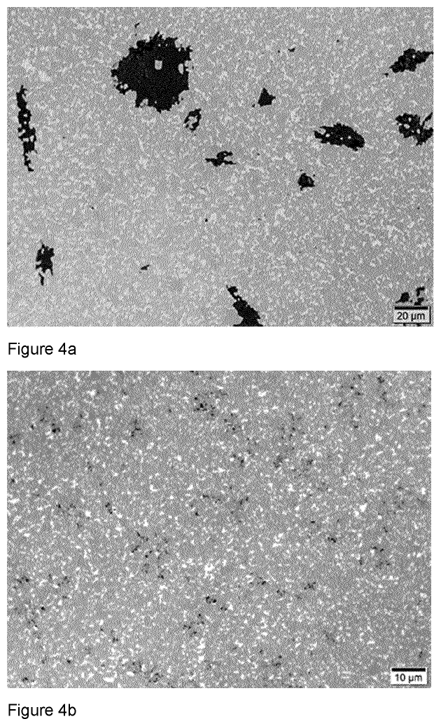

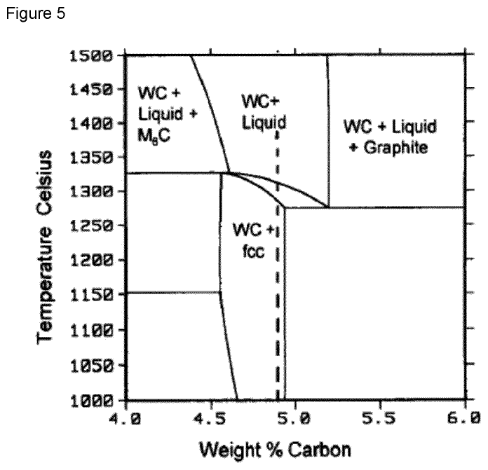

The formation of examples of PCD constructions as shown in FIGS. 3a to 4b is discussed in more detail below with reference to the following examples, which are not intended to be limiting, and with reference to FIG. 5.

A control batch of conventional cemented carbide substrates for a PCD construction was produced by forming a 5 kg powder mixture by milling, in a ball mill, a WC powder having a mean grain size of about 1.3 μm, Co powder having a mean grain size of nearly 1 μm, together with 30 kg carbide balls and 100 g paraffin wax. Once the powder had dried, it was granulated and compacted to form substrates for PCD constructions in the form of green bodies. The equivalent total carbon (ETC) in the cemented carbide material was determined to be around 6.12 percent with respect to WC.

The green bodies were sintered by means of a Sinterhip™ furnace at 1,420 degrees centigrade for about 75 min, 45 min of which was carried out in vacuum and 30 min of which was carried out in a HIP apparatus in an Ar at a pressure of about 40 bars.

Afterwards a layer of polycrystalline diamond was bonded to each of the control carbide substrates by placing the individual substrates into a respective into a cannister and adding a mass of diamond grains or particles to form a second pre-sinter assembly. The second pre-sinter assembly was subsequently treated in the presence of a catalyst/solvent material for diamond at an ultra-high pressure of around 6 GPa or greater, in some examples, around 7 Gpa or greater, and at a temperature of around 1400 degrees C. to sinter together the diamond grains to form the polycrystalline diamond construction.

### EXAMPLE 1

An experimental batch of carbide substrates for a first example PCD construction was produced using the same procedure described above for the control batch except 0.2 wt. % carbon was added to the powder mixture that was to be milled. The equivalent total carbon (ETC) in the cemented carbide material was determined in this first example to be 6.32 percent with respect to WC.

Afterwards a layer of polycrystalline diamond was bonded to the carbide substrates by use of high-pressure and high-temperatures (HPHT) procedures described above to produce a first example set of PCD constructions.

### EXAMPLE 2

Another experimental batch of carbide substrates for forming a second example PCD construction was produced using the same procedure described above for the control batch except 0.5 wt. % carbon was added to the powder mixture that was to be milled. The equivalent total carbon (ETC) in the cemented carbide material was determined to be 6.62 percent with respect to WC.

Afterwards a layer of polycrystalline diamond was bonded to the carbide substrates by use of high-pressure and high-temperatures (HPHT) procedures described above to produce a second example set of PCD constructions.

The magnetic coercivity and other properties of the control carbide substrates and the example carbide substrates was determined using conventional procedures. In particular, the magnetic coercivity of the control carbide substrates was found to be equal to roughly 170 Oe, their magnetic moment to be equal to 13.2 Gcm³/g and density to be equal to 14.15 g/cm³.

By contrast, for the constructions formed according to Example 1, the magnetic coercivity of the carbide substrates was found to be equal to roughly 169 Oe, their magnetic moment to be equal to 13.6 Gcm³/g and density to be equal to 14.0 g/cm³.

For the constructions formed according to Example 2, the magnetic coercivity of the carbide substrates was found to be equal to roughly 170 Oe, their magnetic moment to be equal to 13.7 Gcm³/g and density to be equal to 14.0 g/cm³.

To examine mechanical properties of the control carbide substrates, the PCD layer was removed by EDM cutting. The Vickers hardness of the substrates was determined using conventional testing procedures to be equal to HV₂₀=1230, the transverse rupture strength was determined to be equal to 3700 MPa and the indentation fracture toughness was determined to be equal to 15.3 MPa m^{½}.

To examine mechanical properties of the carbide substrates formed according to Example 1, these were tested under the same conditions as the control substrates after removing the PCD layer by EDM cutting. The Vickers hardness of the substrates of Example 1 was determined to be equal to HV₂₀=1240, the transverse rupture strength was determined to be equal to 2860 MPa and the indentation fracture toughness was determined to be equal to 15.5 MPa m^{½}.

To examine mechanical properties of the carbide substrates formed according to Example 2, these were tested under the same conditions as the control substrates after removing the PCD layer by EDM cutting. The Vickers hardness of the substrates formed according to Example 2 was determined to be equal to HV₂₀=1250, the transverse rupture strength was determined to be equal to 3040 MPa and the indentation fracture toughness was determined to be equal to about 19 MPa m^{½}.

In addition to the mechanical properties, the microstructures of the control substrates and those produced according to Examples 1 and 2 above were examined using conventional high resolution TEM and/or SEM procedures, and were examined after initial sintering of the substrates and again after the sintering stage used to form the PCD construction in which the diamond grains are sintered and bonded to the substrates.

The microstructure of the control carbide substrates when examined using conventional high resolution TEM and SEM procedures was found to be free of free carbon and rt-phase, both before and after second sintering.

Images of the microstructure for the constructions formed according to Example 1 are shown in FIGS. 3a and 3b, before and after second sintering respectively. As can be seen from FIG. 3a, before the second sintering stage, the microstructure was found to comprise inclusions of free carbon and, as seen in FIG. 3b, after second sintering to form the PCD construction of Example 1, the microstructure comprises significantly less inclusions of free carbon in comparison with that before performing the second HPHT procedure, and they are finely and uniformly distributed in the microstructure. Again using the standard TEM procedure, the volume percentage of the inclusions of free carbon shown in FIG. 3b in the substrate of the example PCD construction was determined to be around 0.4 vol. % and these inclusions of free carbon had a largest average size in any one or more dimensions of less than around 40 microns.

Images of the microstructure for the constructions formed according to Example 2 are shown in FIGS. 4a and 4b, before and after second sintering respectively. As can be seen from FIG. 4a, before the second sintering stage, the microstructure of the substrate was found to comprise inclusions of free carbon and, as seen in FIG. 4b, after second sintering to form the PCD construction of Example 2, the microstructure of the example substrate comprises significantly less inclusions of free carbon in comparison with that before performing the second HPHT procedure, and they are finely and uniformly distributed in the microstructure. Again using the standard SEM procedure, the volume percentage of the inclusions of free carbon in the example substrate shown in FIG. 4b in the example PCD construction was determined to be around 1.3 vol. % and the inclusions of free carbon in this example substrate had a largest average size in any one or more dimensions of less than around 40 microns.

The image analysis also showed that for the example PCD constructions no WC platelets (“plumes”) were found at the interface of the body of PCD material and the substrate.

It may therefore be seen that the PCD constructions formed according to Examples 1 and 2 show a favourable combination of mechanical properties, including significantly improved fracture toughness over the control PCD constructions. Whilst not wishing to be bound by any particular theory, it is believed this may be attributed to or assisted by the surprising and unusual microstructure at least of the substrates in the example PCD constructions which are seen to comprise fine carbon inclusions of less than 40 microns in any largest dimension and which are distributed through the bulk of the substrate and, in some examples in substantially homogeneous or uniform distribution.

The conventional teaching on the influence of free carbon precipitates on cemented carbide mechanical properties is that the presence of such precipitates in a cemented carbide microstructure dramatically reduces hardness, toughness and transverse rupture strength (TRS) of the carbide structure (see for example Suzuki, H., Kubota, H., entitled The influence of binder phase composition on the properties of tungsten carbide-cobalt cemented carbides Planseeberichte fuer Pulvermetallurgie 14(2), (1966) 96-109). However, it has been surprisingly found by the present applicants that the example constructions formed by the example methods which combine a body of PCD material with a cemented carbide substrate having a bulk volume comprising at least around 0.1 vol. % of inclusions of free carbon having a largest average size in any one or more dimensions of less than around 40 microns work synergistically and surprisingly to significantly improve fracture toughness over the control PCD constructions. Whilst not wishing to be bound by any particular theory, a possible explanation may be that the applicants have found that carbon solubility in the liquid binders at ultra-high pressures significantly increases and when a large amount of free carbon is present in the microstructure in form of large graphite inclusions as seen in FIGS. 3a and 4a before the second sintering stage, these may be dissolved in the liquid binder during the second sintering stage, that is during the PCD sintering stage. As a result of solidification after the PCD sintering stage, the excess of carbon precipitates in the substrate in the form of extremely fine and uniformly distributed particles, as shown in FIGS. 3b and 4b, which very surprisingly do not appear to adversely impact the mechanical properties of the PCD construction.

Additionally, it was found that the formation of the WC plumes may be suppressed by in and by the example methods of forming example PCD constructions.

Also, it is believed that the example methods and in particular addition of the mass of carbon prior to sintering may have desirable sintering aid properties. Whilst not wishing to be bound by theory, a possible explanation may be that, the if the liquid binder is saturated or oversaturated with carbon during PCD press sintering, its melting point is reduced according to the W-Co-C phase diagram as shown in FIG. 5 (see B. Uhrenius, H. Pastor, E. Pauty, on The composition of Fe-Ni-Co-WC-based cemented carbides, Int. J Refractory Met Hard Mater., 15(1997)139-149). As a result, a rate of the solid-state densification of diamond grits obtained before binder melting when increasing the temperature of PCD press sintering is reduced compared to conventional sintering techniques of conventional PCD constructions and infiltration of the PCD table by the liquid binder may occur earlier in the sintering cycle than in conventional sintering techniques leading to improved sintering.

While various examples have been described with reference to a number of examples, those skilled in the art will understand that various changes may be made and equivalents may be substituted for elements thereof and that these examples are not intended to limit the particular examples disclosed. In particluar whilst standard SEM and TEM imaging techniques may be used to determine the vol % of inclusions, conventional optical microscopy techniques may also be used.

1. A polycrystalline diamond construction comprising:
a body of polycrystalline diamond (PCD) material; and
a cemented carbide substrate bonded to the body of polycrystalline material along an interface; wherein
the cemented carbide substrate comprises tungsten carbide particles bonded together by a binder material, the binder material comprising Co; and
the tungsten carbide particles form at least around 70 weight percent and at most around 95 weight percent of the substrate;
wherein the cemented carbide substrate has a bulk volume, the bulk volume of the cemented carbide substrate comprising at least around 0.1 vol. % to around 3 vol % of inclusions of any one or more of free carbon, SP²-hybridised carbon, or SP³-hybridised carbon, the inclusions having a largest average size in any one or more dimensions of less than around 40 microns.

2. The polycrystalline diamond construction according to claim 1, the inclusions in the bulk volume of the cemented carbide substrate having an average size of less than around 30 microns.

3. The polycrystalline diamond construction according to claim 1, the inclusions in the bulk volume of the cemented carbide substrate having an average size of less than around 10 microns.

4. The polycrystalline diamond construction according to claim 1, wherein the bulk volume of the cemented carbide substrate comprises at least around 0.3 vol. % to around 3 vol % of the inclusions.

5. The polycrystalline diamond construction according to claim 1, wherein the inclusions form at least around 0.1 vol % to around 2.5 vol % of the bulk volume of the cemented carbide substrate.

6. (canceled)

7. The polycrystalline diamond construction according to claim 1, wherein the inclusions comprise any one or more of graphite, and diamond.

8. The polycrystalline diamond construction according to claim 1, wherein the binder material of the substrate comprises up to around 50 wt. % Fe.

9. The polycrystalline diamond construction according to claim 1, wherein the binder material comprises between about 0.1 to about 4 wt. % tungsten and between about 0.05 to about 5 wt. % carbon in solid solution form.

10. The A polycrystalline diamond construction according to claim 1, wherein the binder material comprises at least about 0.1 weight percent to at most about 5 weight percent of any one or more of V, Ta, Ti, Mo, Zr, Nb, Hf in the form of a solid solution or a carbide phase.

11. The polycrystalline diamond construction according to claim 1, wherein the binder material comprises at least about 0.1 weight percent and at most about 2 weight percent of any one or more of Re, Ru, Rh, Pd, Re, Os, Ir and Pt in solid solution.

12. (canceled)

13. The polycrystalline diamond construction according to claim 1, further comprising a second cemented carbide substrate bonded to the cemented carbide substrate along a second interface opposite said interface with the body of PCD material, the second substrate comprising substantially no inclusions of free carbon.

14. The polycrystalline diamond construction according claim 1, wherein an interfacial region between the cemented carbide substrate and the body of PCD material comprises substantially no platelet-like WC grains.

15. A method of making the polycrystalline diamond construction of claim 1, the method comprising:
milling a tungsten carbide powder with a binder material and a mass of carbon to form a milled powder, the binder material comprising Co; and the mass of carbon comprising any one or more of graphite or amorphous carbon in an amount corresponding to the equivalent carbon content (ETC) with respect to the milled WC powder of equal to or more than around 6.2 wt. %;
compacting the milled powder to form a green body;
sintering the green body in a vacuum or inert gas atmosphere to form a first pre-composite body;
sintering the first pre-composite body to form a cemented carbide substrate;
placing the cemented carbide substrate into a cannister and adding a mass of diamond grains or particles to form a second pre-sinter assembly; and
treating the second pre-sinter assembly in the presence of a catalyst/solvent material for diamond at an ultra-high pressure of around 6 GPa or greater and a temperature at which the diamond material is more thermodynamically stable than graphite to sinter together the diamond grains to form the polycrystalline diamond compact element.

16. The method as claimed in claim 15, wherein the step of sintering the green body to form the pre-composite body comprises heating the green body up to a temperature of at least around 300° C. in a vacuum followed by annealing for at least around 5 minutes.

17. The method of claim 15, further comprising prior to the step of placing the cemented carbide substrate into the canister, forming the cemented carbide substrate by:
forming a cemented carbide disc of at least around 2 mm in thickness, the disc comprising binder material comprising Co, and at least about 0.1 vol. % carbon inclusions in form of graphite;
forming an additional cemented carbide post having a binder material comprising Co; and
bonding the disc and the post together by sintering either at ambient conditions or at ultra-high pressure to form the cemented carbide substrate for placing into the canister with the mass of diamond grains or particles.

18. The method of claim 15, further comprising pressing the milled powder onto or around a cemented carbide post having a binder material comprising Co to form the green body; and wherein
the step of sintering the green body comprises sintering the posts with a layer of the milled powder at a temperature in the range of between about 1350° C. to about 1400° C. for between about 10 to about 60 minutes in a vacuum or protective gas.

19. The method of claim 17 wherein the step of bonding the disc and the post comprises brazing the disc to the post to bond the disc and the post together.

20. The method of claim 19 wherein the step of brazing comprises placing a barrier interlayer between the post and the disc, the barrier layer having a thickness of at least around 10 μm and comprising any one or more of a metal, a metal carbide, nitride or carbonitride.

21. The method of claim 15 further comprising after the step of sintering the first pre-composite body to form the cemented carbide substrate selectively de-carburizing a portion of the cemented carbide substrate in a hydrogen atmosphere or an atmosphere of CO₂ at a temperature of at least around 700° C. for at least around 1 hour, the portion having a thickness of at least around 50% of the total height of the cemented carbide substrate.

22. The method of claim 15 further comprising after the step of sintering the first pre-composite body to form the cemented carbide substrate carburizing the cemented carbide substrate in an atmosphere comprising any one or more of a hydrocarbon gas, an inert gas or hydrogen at a temperature of at least around 1350° C. for between around 1 hour to around 10 hours.

23. The method of claim 15 further comprising carburizing the green body in an atmosphere comprising any one or more of a hydrocarbon gas, hydrogen or an inert gas at a temperature of at least around 1350° C. for between around 1 hour to around 10 hours.

24. The method of claim 22. wherein the step of carburizing comprises treating the cemented carbide substrate or green body with a powder mixture comprising any one or more of carbon black, graphite or a carbon-containing precursor in an atmosphere comprising any one or more of an inert gas, hydrogen or a gaseous mixture comprising hydrocarbons at a temperature of above around 1000° C. for at least around 1 hour.

25. The method of claim 15. wherein the step of treating the second pre-sinter assembly comprises:
subjecting the assembly to a sufficiently high temperature for the catalyst/solvent to be in a liquid state and to a first pressure at which diamond is thermodynamically stable;
reducing the first pressure to a second pressure at which the diamond is thermodynamically stable, the temperature being maintained sufficiently high to maintain the catalyst/binder in the liquid state;
reducing the temperature to solidify the catalyst/binder; and
reducing the pressure and the temperature to an ambient condition to form a body of poly crystal line diamond material bonded to the cemented carbide substrate.

26.-30. (canceled)
